(19) United States
(12) Patent Application Publication
(10) Pub. No.: US 2017/0033895 A1
(43) Pub. Date: Feb. 2, 2017

(54) SCALABLE PROJECTION-BASED MIMO DETECTOR

(71) Applicant: QUALCOMM Incorporated, San Diego, CA (US)

(72) Inventor: Louay Jalloul, San Jose, CA (US)

(21) Appl. No.: 15/005,575

(22) Filed: Jan. 25, 2016

Related U.S. Application Data
(60) Provisional application No. 62/198,607, filed on Jul. 29, 2015.

(51) Int. Cl. H04L 1/06; H04L 1/00; H04L 25/02

(52) U.S. Cl. CPC H04L 1/0631; H04L 25/0242; H04L 1/0054

(57) ABSTRACT

Systems and methods are disclosed that may detect data transmitted using MIMO communications. Data may be received, on a wireless channel, as a plurality of spatial streams. A channel matrix characterizing the wireless channel may also be received. The channel matrix may be decomposed into a first sub-channel matrix and a second sub-channel matrix, each having a lower dimension than the channel matrix. A first estimated data signal may be generated based at least in part on the plurality of spatial streams and the first sub-channel matrix. A second estimated data signal may be generated based at least in part on the plurality of spatial streams and the second sub-channel matrix. The first and second estimated data signals may be combined to recover the data.

### RELATED APPLICATION

This application claims priority to co-pending and commonly-owned U.S. Provisional Patent Application No. 62/198,607, titled “Scalable Projection-Based MIMO Detector,” filed Jul. 29, 2015, which is hereby incorporated by reference in its entirety.

### TECHNICAL FIELD

The example embodiments relate generally to wireless communications systems, and specifically to methods of multi-user multiple-input multiple-output communications.

### BACKGROUND OF RELATED ART

A wireless local area network (WLAN) may be formed by one or more access points (APs) that provide a shared wireless communication medium for use by a number of client devices such as mobile stations (STAs). Multiple-input multiple-output (MIMO) signaling techniques allow an AP to transmit data to the STAs using multiple spatial streams, which may provide many advantages (e.g., higher throughput, extended coverage, increased diversity, and/or interference suppression) over conventional single antenna transmission techniques. For example, in a single-user MIMO (SU-MIMO) environment, the AP may use multiple antennas to transmit data to a single STA using multiple spatial streams, and the STA may use multiple antennas to receive the multiple spatial streams. The STA recovers the original data by decoding the received multiple spatial streams.

In MIMO communications, the number of spatial streams transmitted to the STA may depend upon the number of antennas available to the STA. For example, if the STA includes two antennas, then the AP may transmit data to the STA as two spatial streams (e.g., according to a 2×2 MIMO configuration); if the STA includes three antennas, then the AP may transmit data to the STA as three spatial streams (e.g., according to a 3×3 MIMO configuration); and so on. Because signal diversity and interference suppression may increase with greater numbers of spatial streams, the AP typically transmits data to the STA using the maximum number of spatial streams supported by the STA. Thus, if the STA indicates (e.g., during association) that it includes two antennas, and thus may support a 2×2 MIMO configuration, the AP may transmit data to the STA using two spatial streams.

Recent revisions to the IEEE 802.11 standards require support for detection of increasingly greater numbers of spatial streams. For example, one such requirement requires next generation WLAN devices to support detection of up to 8 spatial streams. Using current MIMO detectors in systems including greater numbers of spatial streams (e.g., more than 4 spatial streams) may be impractical, for example, due to the increased computational complexity associated with greater numbers of spatial streams. In a multi-user MIMO transmission scenario, multiple STA may transmit to a single AP. The AP receiver needs to demodulate all users. For example, an AP with 8 receive antennas may process transmissions from 8 STA each transmitting a single spatial stream.

Thus, it would be desirable to facilitate MIMO detection of greater numbers of spatial streams without a significant increase in the computational complexity of MIMO detectors.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the disclosure are directed to apparatuses and methods for detecting data transmitted using multiple-input multiple-output (MIMO) communications. In one example, a method for detecting data transmitted using MIMO communications is disclosed. The method may include receiving, on a wireless channel, data as a plurality of spatial streams; receiving a channel matrix characterizing the wireless channel; decomposing the channel matrix into a first sub-channel matrix and a second sub-channel matrix, the first sub-channel matrix and the second sub-channel matrix each having a lower dimension than the channel matrix; generating a first estimated data signal based at least in part on the plurality of spatial streams and the first sub-channel matrix; generating a second estimated data signal based at least in part on the plurality of spatial streams and the second sub-channel matrix; and combining the first and second estimated data signals to recover the data.

In another example, an apparatus for detecting data transmitted using MIMO communications is disclosed. The apparatus may include means for receiving, on a wireless channel, data as a plurality of spatial streams; means for receiving a channel matrix characterizing the wireless channel; means for decomposing the channel matrix into a first sub-channel matrix and a second sub-channel matrix, the first sub-channel matrix and the second sub-channel matrix each having a lower dimension than the channel matrix; means for generating a first estimated data signal based at least in part on the plurality of spatial streams and the first sub-channel matrix; means for generating a second estimated data signal based at least in part on the plurality of spatial streams and the second sub-channel matrix; and means for combining the first and second estimated data signals to recover the data.

In another example, a non-transitory computer-readable storage medium is disclosed. The non-transitory computer-readable storage medium may store instructions that, when executed by one or more processors of a communication device, cause the communication device to perform operations including: receiving, on a wireless channel, data as a plurality of spatial streams; receiving a channel matrix characterizing the wireless channel; decomposing the channel matrix into a first sub-channel matrix and a second sub-channel matrix, the first sub-channel matrix and the second sub-channel matrix each having a lower dimension than the channel matrix; generating a first estimated data signal based at least in part on the plurality of spatial streams and the first sub-channel matrix; generating a second estimated data signal based at least in part on the plurality of spatial streams and the second sub-channel matrix; and combining the first and second estimated data signals to recover the data.

In another example, an apparatus for detecting data transmitted using MIMO communications is disclosed. The apparatus may include a number of antennas configured to receive, on a wireless channel, data as a plurality of spatial streams; a circuit configured to receive or store a channel matrix that characterizes the wireless channel; a first projector configured to decompose the channel matrix into a first sub-channel matrix; a second projector configured to decompose the channel matrix into a second sub-channel matrix, the first sub-channel matrix and the second sub-channel matrix each having a lower dimension than the channel matrix; a first detector configured to generate a first estimated data signal based at least in part on the plurality of spatial streams and the first sub-channel matrix; a second detector configured to generate a second estimated data signal based at least in part on the plurality of spatial streams and the second sub-channel matrix; a serializer configured to combine the first and second estimated data signals into a serial bit stream; and a decoder configured to recover the data from the serial bit stream.

### BRIEF DESCRIPTION OF THE DRAWINGS

The example embodiments are illustrated by way of example and are not intended to be limited by the figures of the accompanying drawings, where:

FIG. 1 shows an example wireless system within which the example embodiments may be implemented.

FIG. 2 shows a block diagram of a wireless station (STA) in accordance with example embodiments.

FIG. 3 shows a block diagram of an access point (AP) in accordance with example embodiments.

FIG. 4 shows an example MIMO receiver, in accordance with example embodiments.

FIG. 5A depicts the transmission of data from a transmit (TX) device to a receive (RX) device using multi-user MIMO (MU-MIMO) communications, in accordance with example embodiments.

FIG. 5B depicts the transmission of data from multiple TX devices to an RX device using multi-user MIMO (MU-MIMO) communications, in accordance with example embodiments.

FIG. 6 depicts an example linear MU-MIMO detector in a wireless system including 8 spatial streams.

FIG. 7 depicts an example projection-based 8-spatial stream detector, in accordance with example embodiments.

FIG. 8A shows an example channel matrix H split into two sub-matrices H₁ and H₂, in accordance with example embodiments.

FIGS. 8B-8C show example sub-matrices H₁ and H₂, respectively, for a wireless system including 8 spatial streams, in accordance with example embodiments.

FIG. 9 depicts an example projection-based 16-spatial stream detector, in accordance with example embodiments.

FIG. 10 shows an illustrative flowchart depicting an example operation for detecting MIMO communications, in accordance with example embodiments.

FIG. 11 is another block diagram of several sample aspects of apparatuses configured to detect data transmitted using MIMO communications as taught herein.

### DETAILED DESCRIPTION

Apparatuses and methods are disclosed that may detect data transmitted using multiple-input multiple-output (MIMO) communications by decomposing a channel matrix into a plurality of sub-channel matrices that are smaller than the original channel matrix. Each of the plurality of sub-channel matrices may be used to generate a signal indicative of a corresponding portion of the transmitted data. The signals may be combined to recover the transmitted data. Because the sub-channel matrices are smaller than the original channel matrix, smaller and less-complex MIMO detectors may be used to recover the transmitted data, for example, as compared with more-complex MIMO detector typically used in conjunction with the original channel matrix.

The example embodiments are described below in the context of Wi-Fi enabled devices for simplicity only. It is to be understood that the example embodiments are equally applicable to other wireless networks (e.g., 3GPP-LTE (long term evolution) standard, cellular networks, pico networks, femto networks, satellite networks), as well as for systems using signals of one or more wired standards or protocols (e.g., Ethernet and/or HomePlug/PLC standards). As used herein, the terms “wireless local area network (WLAN)” and “Wi-Fi” can include communications governed by the IEEE 802.11 standards, BLUETOOTH® (Bluetooth), HiperLAN (a set of wireless standards, comparable to the IEEE 802.11 standards, used primarily in Europe), and other technologies used in wireless communications such as LTE. In addition, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PD Us), media access control (MAC) protocol data units (MPDUs), and physical (PHY) layer convergence procedure protocol data units (PPDUs). The term “A-MPDU” may refer to aggregated MPDUs.

The terminology used herein is for the purpose of describing particular aspects only and is not intended to be limiting of the aspects. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “I” between two adjacent words has the same meaning as “or” unless expressly stated otherwise. Moreover, phrases such as “connected to,” “coupled to” or “in communication with” are not limited to direct connections unless expressly stated otherwise.

Further, many aspects are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application specific integrated circuits (ASICs), field programmable gate arrays (FPGAs), or various other types of general purpose or special purpose processors or circuits, by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. Embodiments of this disclosure are not to be construed as limited to specific examples described herein but rather to include within their scope all embodiments defined by the appended claims.

As described above, recent revisions to the IEEE 802.11 family of standards require WLAN devices to support detection of increasing numbers of spatial streams (SS). For example, recent revisions to the IEEE 802.11ac and IEEE 802.11ax standards require support for up to eight (8) spatial streams. The use of current MIMO detectors, such as near-maximum likelihood (ML) MIMO detectors, to support detection of 8 spatial streams may be impractical, due to the increased computational complexity associated with greater numbers of spatial streams. More specifically, a linear increase in the number of spatial streams may result in an exponential increase in the complexity of ML MIMO detectors. It is therefore desirable to provide lower-complexity methods and apparatuses for detection of 8 or more MIMO spatial streams.

Accordingly, the example embodiments describe methods and systems for providing lower complexity detection of 8 or more MIMO spatial streams by decomposing the wireless channel using projections into two sub-channels of lower dimension. These lower-dimension sub-channels may then be detected using two MIMO cores that are of half the dimension, which are exponentially less complex than an 8-spatial stream MIMO core. In some examples, the number of spatial streams may be 8 and the two sub-channels of lower dimension may use a 4 spatial stream MIMO detector. Example embodiments may employ projections such as orthogonal null projection or a non-orthogonal pre-whitening projection. The example embodiments may be applicable to any number of spatial streams using multiple stages of decompositions and projections. These and other details of the example embodiments, which provide one or more technical solutions to the aforementioned technical problems, are described in more detail below.

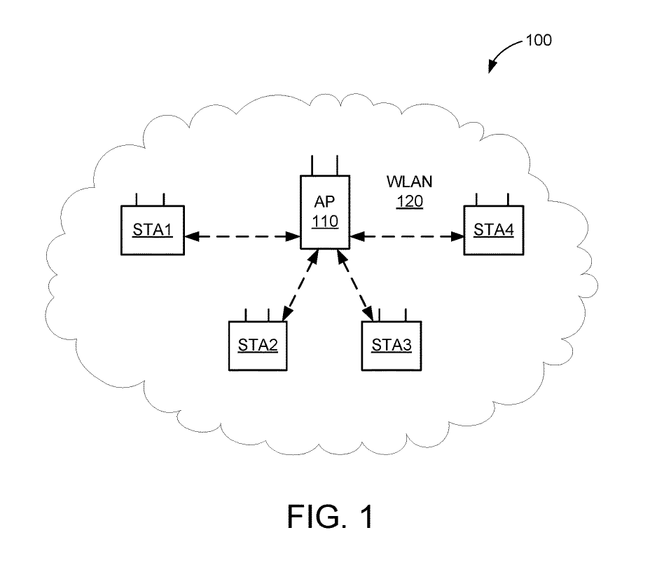

FIG. 1 is a block diagram of a wireless system 100 within which the example embodiments may be implemented. The system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique MAC address that is programmed therein by, for example, the manufacturer of the access point. Similarly, each of STA1-STA4 is also assigned a unique MAC address. For some embodiments, the wireless system 100 may correspond to a multiple-input multiple-output (MIMO) wireless network.

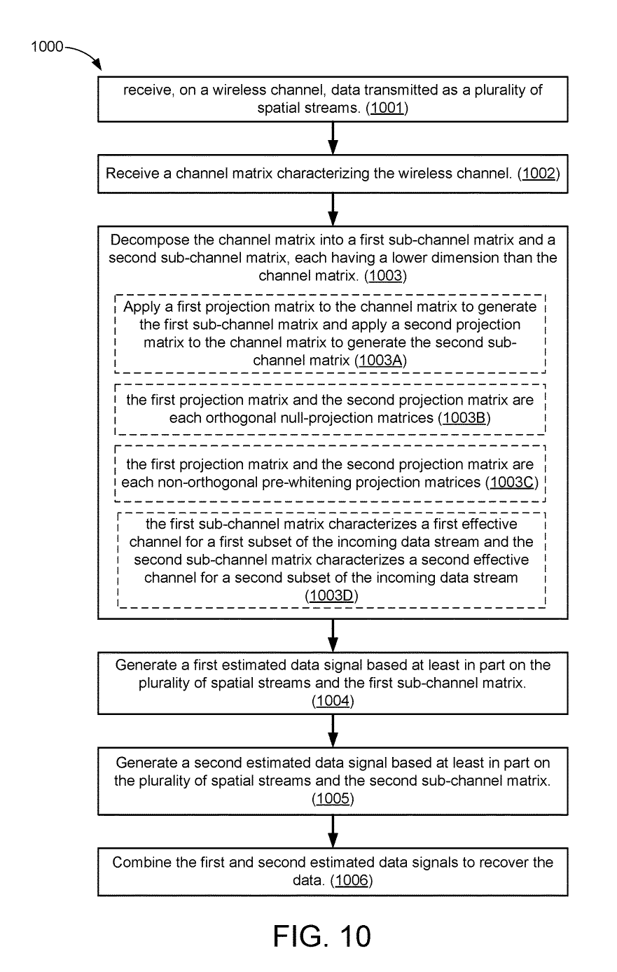

Each of stations STA1-STA4 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station STA may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 10.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. For at least one embodiment, AP 110 may include one or more transceivers, a network interface, one or more processing resources, and one or more memory resources. The memory resources may include a non-transitory computer-readable medium (e.g., one or more nonvolatile memory elements, such as EPROM, EEPROM, Flash memory, a hard drive, etc.) that stores instructions for performing operations described operations described above or below with respect to FIG. 10.

For the stations STA1-STA4 and/or AP 110, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within stations STA1-STA4 may be any technically feasible transceiver such as a ZigBee transceiver described by a specification from the ZigBee specification, a WiGig transceiver, and/or a HomePlug transceiver described a specification from the HomePlug Alliance.

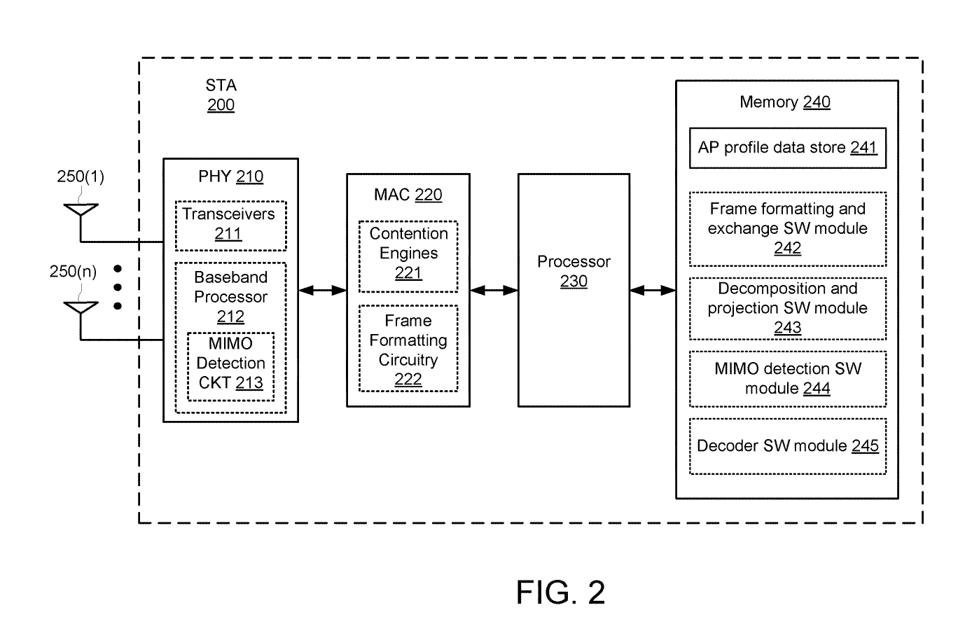

FIG. 2 shows an example STA 200 that may be one embodiment of each of the stations STA1-STA4 of FIG. 1. The STA 200 may include a PHY device 210 including at least a number of transceivers 211, a baseband processor 212, including a MIMO detection circuit 213, may include a MAC 220 including at least a number of contention engines 221 and frame formatting circuitry 222, may include a processor 230, may include a memory 240, and may include a number of antennas 250(1)-250(n). The transceivers 211 may be coupled to antennas 250(1)-250(n), either directly or through an antenna selection circuit (not shown for simplicity). The transceivers 211 may be used to transmit signals to and receive signals from AP 110 and/or other STAs (see also FIG. 1), and may be used to scan the surrounding environment to detect and identify nearby access points and/or other STAs (e.g., within wireless range of STA 200). Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, for example embodiments, the STA 200 may be configured for MIMO operations. The MIMO operations may include single-user MIMO (SU-MIMO) operations and multi-user MIMO (MU-MIMO) operations.

The baseband processor 212 may be used to process signals received from processor 230 and/or memory 240 and to forward the processed signals to transceivers 211 for transmission via one or more of antennas 250(1)-250(n), and may be used to process signals received from one or more of antennas 250(1)-250(n) via transceivers 211 and to forward the processed signals to processor 230 and/or memory 240.

The MIMO detection circuit 213 may be used to detect a number of spatial streams transmitted according to one or more MIMO communication modes, for example, as described in more detail below.

For purposes of discussion herein, MAC 220 is shown in FIG. 2 as being coupled between PHY device 210 and processor 230. For actual embodiments, PHY device 210, MAC 220, processor 230, and/or memory 240 may be connected together using one or more buses (not shown for simplicity).

The contention engines 221 may contend for access to one or more shared wireless mediums, and may also store packets for transmission over the one or more shared wireless mediums. The STA 200 may include one or more contention engines 221 for each of a plurality of different access categories. For other embodiments, the contention engines 221 may be separate from MAC 220. For still other embodiments, the contention engines 221 may be implemented as one or more software modules (e.g., stored in memory 240 or stored in memory provided within MAC 220) containing instructions that, when executed by processor 230, perform the functions of contention engines 221.

The frame formatting circuitry 222 may be used to create and/or format frames received from processor 230 and/or memory 240 (e.g., by adding MAC headers to PDUs provided by processor 230), and may be used to re-format frames received from PHY device 210 (e.g., by stripping MAC headers from frames received from PHY device 210).

Memory 240 may include an AP profile data store 241 that stores profile information for a plurality of APs. The profile information for a particular AP may include information including, for example, the AP's SSID, MAC address, channel information, received signal strength indication (RSSI) values, goodput values, channel state information (CSI), supported data rates, MIMO capabilities, connection history with the AP, a trustworthiness value of the AP (e.g., indicating a level of confidence about the AP's location, etc.), and any other suitable information pertaining to or describing the operation of the AP.

Memory 240 may also include a non-transitory computer-readable medium (e.g., one or more nonvolatile memory elements, such as EPROM, EEPROM, Flash memory, a hard drive, and so on) that may store at least the following software (SW) modules:

a frame formatting and exchange software module 242 to facilitate the creation and exchange of any suitable frames (e.g., data frames, action frames, and management frames) between STA 200 and other wireless devices (e.g., as described below for one or more operations of FIG. 10); a decomposition and projection software module 243 to facilitate channel estimation and decomposition operations such as OR matrix decomposition operations, and to facilitate the determination and application of projections to data streams, channel matrices and sub-matrices (e.g., as described below for one or more operations of FIG. 10);

a MIMO detection software module 244 to facilitate the calculation of likelihood ratios (such as log likelihood ratio streams) based on input data stream projections (e.g., as described below for one or more operations of FIG. 10); and a decoder software module 245 to facilitate the determination of estimated transmitted data streams (e.g., bit streams) based on received likelihood ratios (e.g., as described below for one or more operations of FIG. 10).

Each software module includes instructions that, when executed by processor 230, cause STA 200 to perform the corresponding functions. The non-transitory computer-readable medium of memory 240 thus includes instructions for performing all or a portion of the STA-side operations depicted in FIG. 10.

Processor 230, which is shown in the example of FIG. 2 as coupled to PHY device 210, to MAC 220, and to memory 240, may be any suitable one or more processors capable of executing scripts or instructions of one or more software programs stored in STA 200 (e.g., within memory 240). For example, processor 230 may execute the frame formatting and exchange software module 242 to facilitate the creation and exchange of any suitable frames (e.g., data frames, action frames, and management frames) between STA 200 and other wireless devices. Processor 230 may also execute the decomposition and projection software module 243 to facilitate channel estimation and decomposition operations such as OR matrix decomposition operations, and to facilitate the determination and application of projections to data streams, channel matrices and sub-matrices. Processor 230 may also execute the MIMO detection software module 244 to facilitate the calculation of likelihood ratios (such as log likelihood ratio streams) based on input data stream projections. Processor 230 may also execute the decoder software module 245 to facilitate the determination of estimated transmitted data streams (e.g., bit streams) based on received likelihood ratios.

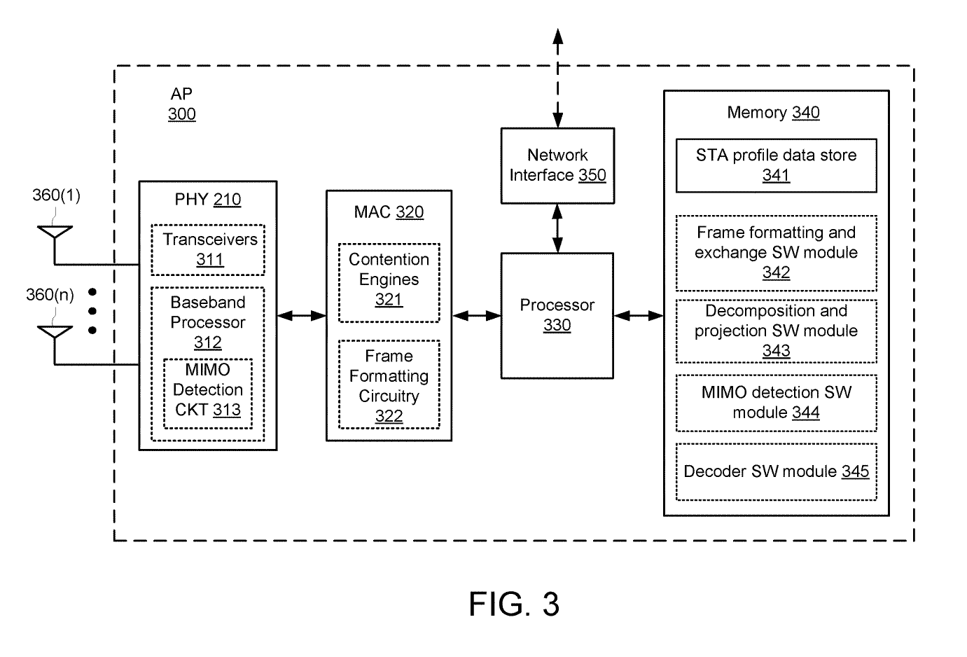

FIG. 3 shows an example AP 300 that may be one embodiment of the AP 110 of FIG. 1. AP 300 may include a PHY device 310 including at least a number of transceivers 311, a baseband processor 312, including a MIMO detection circuit 313, may include a MAC 320 including at least a number of contention engines 321 and frame formatting circuitry 322, may include a processor 330, may include a memory 340, may include a network interface 350, and may include a number of antennas 360(1)-360(n). The transceivers 311 may be coupled to antennas 360(1)-360(n), either directly or through an antenna selection circuit (not shown for simplicity). The transceivers 311 may be used to communicate wirelessly with one or more STAs, with one or more other APs, and/or with other suitable devices. Although not shown in FIG. 3 for simplicity, the transceivers 311 may include any number of transmit chains to process and transmit signals to other wireless devices via antennas 360(1)-360(n), and may include any number of receive chains to process signals received from antennas 360(1)-360(n). Thus, for example embodiments, the AP 300 may be configured for MIMO operations including, for example, SU-MIMO operations and MU-MIMO operations.

The baseband processor 312 may be used to process signals received from processor 330 and/or memory 340 and to forward the processed signals to transceivers 311 for transmission via one or more of antennas 360(1)-360(n), and may be used to process signals received from one or more of antennas 360(1)-360(n) via transceivers 311 and to forward the processed signals to processor 330 and/or memory 340.

The MIMO detection circuit 313 may be used to detect and decode a number of spatial streams transmitted according to one or more MIMO communication modes, for example, as described in more detail below.

The network interface 350 may be used to communicate with a WLAN server (not shown for simplicity) either directly or via one or more intervening networks and to transmit signals.

Processor 330, which is coupled to PHY device 310, to MAC 320, to memory 340, and to network interface 350, may be any suitable one or more processors capable of executing scripts or instructions of one or more software programs stored in AP 300 (e.g., within memory 340). For purposes of discussion herein, MAC 320 is shown in FIG. 3 as being coupled between PHY device 310 and processor 330. For actual embodiments, PHY device 310, MAC 320, processor 330, memory 340, and/or network interface 350 may be connected together using one or more buses (not shown for simplicity).

The contention engines 321 may contend for access to the shared wireless medium, and may also store packets for transmission over the shared wireless medium. For some embodiments, AP 300 may include one or more contention engines 321 for each of a plurality of different access categories. For other embodiments, the contention engines 321 may be separate from MAC 320. For still other embodiments, the contention engines 321 may be implemented as one or more software modules (e.g., stored in memory 340 or within memory provided within MAC 320) containing instructions that, when executed by processor 330, perform the functions of contention engines 321.

The frame formatting circuitry 322 may be used to create and/or format frames received from processor 330 and/or memory 340 (e.g., by adding MAC headers to PDUs provided by processor 330), and may be used to re-format frames received from PHY device 310 (e.g., by stripping MAC headers from frames received from PHY device 310).

Memory 340 may include a STA profile data store 341 that stores profile information for a plurality of STAs. The profile information for a particular STA may include information including, for example, its MAC address, supported data rates, MIMO capabilities, connection history with AP 300, and any other suitable information pertaining to or describing the operation of the STA.

Memory 340 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 342 to facilitate the creation and exchange of any suitable frames (e.g., data frames, action frames, and management frames) between AP 300 and other wireless devices (e.g., as described below for one or more operations of FIG. 10);
a decomposition and projection software module 343 to facilitate channel estimation and decomposition operations such as OR matrix decomposition operations, and to facilitate the determination and application of projections to data streams, channel matrices and sub-matrices (e.g., as described below for one or more operations of FIG. 10);
a MIMO detection software module 344 to facilitate the calculation of likelihood ratios (such as log likelihood ratio streams) based on input data stream projections (e.g., as described below for one or more operations of FIG. 10); and
a decoder software module 345 to facilitate the determination of estimated transmitted data streams (e.g., bit streams) based on received likelihood ratios (e.g., as described below for one or more operations of FIG. 10).
   Each software module includes instructions that, when executed by processor 330, cause AP 300 to perform the corresponding functions. The non-transitory computer-readable medium of memory 340 thus includes instructions for performing all or a portion of the AP-side operations depicted in FIG. 10.

Processor 330, which is shown in the example of FIG. 3 as coupled to PHY device 310 via MAC 320, to memory 340, and to network interface 350, may be any suitable one or more processors capable of executing scripts or instructions of one or more software programs stored in AP 300 (e.g., within memory 340). For example, processor 330 may execute the frame formatting and exchange software module 342 to facilitate the creation and exchange of any suitable frames (e.g., data frames, action frames, and management frames) between AP 300 and other wireless devices. Processor 330 may also execute the decomposition and projection software module 343 to facilitate channel estimation and decomposition operations such as OR matrix decomposition operations, and to facilitate the determination and application of projections to data streams, channel matrices and sub-matrices. Processor 330 may also execute the MIMO detection software module 344 to facilitate the calculation of likelihood ratios (such as log likelihood ratio streams) based on input data stream projections. Processor 330 may also execute the decoder software module 345 to facilitate the determination of estimated transmitted data streams (e.g., bit streams) based on received likelihood ratios.

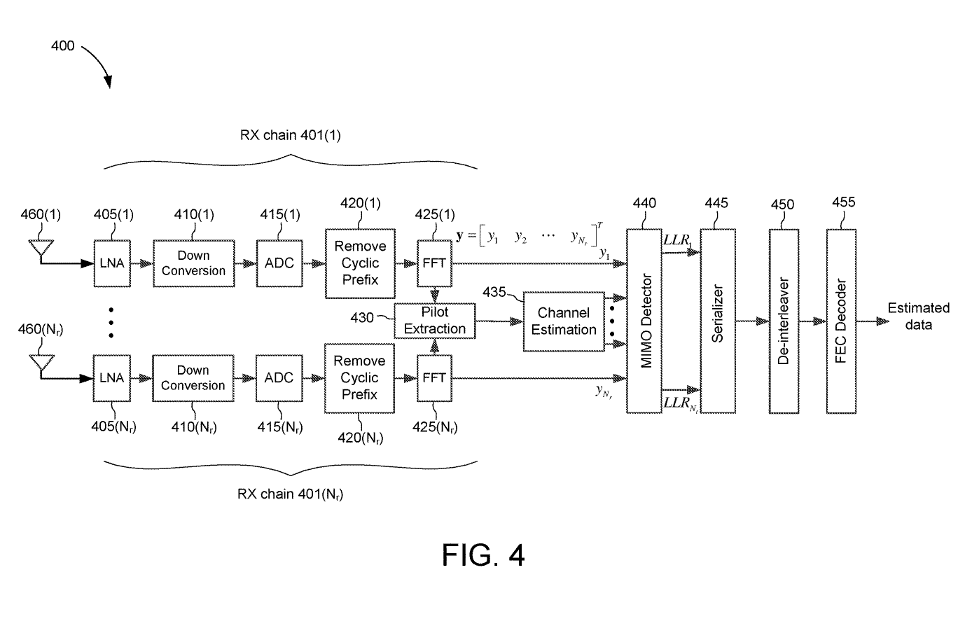

FIG. 4 shows a MIMO receiver 400 in accordance with the example embodiments. The MIMO receiver 400 may be implemented within transceivers 211 of STA 200 (see FIG. 2) and/or within transceivers 311 of AP 300 (see FIG. 3). As shown in FIG. 4, MIMO receiver 400 may include a number Nᵣ of receive antennas 460(1)-460(Nᵣ), which for some embodiments may be antennas 260(1)-260(n) of STA 200 and/or antennas 360(1)-360(n) of AP 300. The antennas 460(1)-460(Nᵣ) may receive data as a number Nₜ of spatial streams, which may be processed to determine (i) a receive data stream y and (ii) a channel estimation matrix H. The MIMO receiver 400 may include a plurality of receive (RX) chains 401(1)-401(Nᵣ), each coupled to a corresponding one of antennas 460(1)-460(Nᵣ). For example, after a first signal is received by antenna 460(1), the first signal may be processed by a first receive chain 401(1) that may include a low noise amplifier (LNA) 405(1), a down conversion circuit 410(1), an analog-to-digital converter (ADC) 415(1), a cyclic prefix remover 420(1), fast Fourier transform (FFT) logic 425(1), pilot extraction logic 430, and channel estimation logic 435. The down conversion circuit 410(1) may generate in-phase and quadrature signals (not shown in FIG. 4 for simplicity), for example, using one or more local oscillator signals (not shown in FIG. 4 for simplicity). The ADC 415(1) may be a pair of ADCs to process the in-phase and quadrature signals generated by the down conversion circuit 410(1). For the example of FIG. 4, signals received by antennas 460(2)-460(Nᵣ) may be processed in a similar manner by RX chains 401(2)-401(Nᵣ), respectively.

In the case of single user MIMO (SU-MIMO), a receive data vector y and a channel estimation matrix H may be provided to MIMO detector 440 to produce log likelihood ratios (LLRs) LLR₁-LLR_{Nt}. The LLRs may be serialized by a serializer 445 to generate a serial data stream. For some embodiments, the serializer 445 may be implemented as a multiplexer, for example, controlled by a select signal (not shown for simplicity) that consecutively selects each of the LLR₁-LLR_{Nt} signals to generate the serial data stream. The serial data stream may be provided to de-interleaver 450, which de-interleaves the serial data stream. The resulting de-interleaved serial data stream may be provided to forward error correction (FEC) decoder 455. FEC decoder 455 may generate an estimate of the received data. In the case of multi-user MIMO (MU-MIMO), the LLR streams from all the users may not be multiplexed together for decoding instead, LLR streams belonging to given transmitters may be decoded separately.

For other embodiments, the order of serializer 445 and de-interleaver 450 may be reversed, for example, so that the de-interleaver 450 de-interleaves the LLR₁-LLR_{Nt} signals, and the serializer 445 converts the de-interleaved LLR signals into a serial data stream. The details of de-interleaving and decoding are well known in the art.

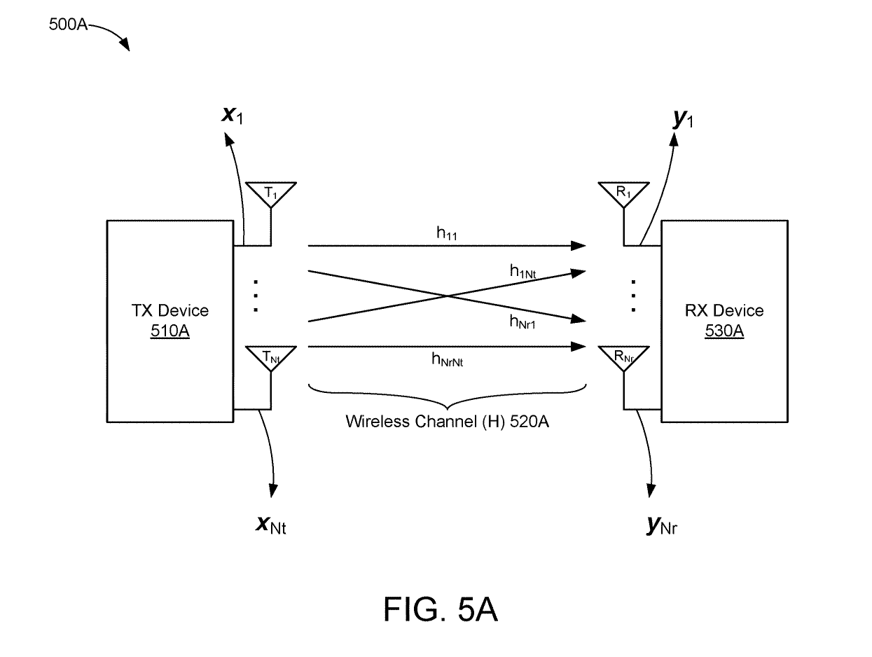

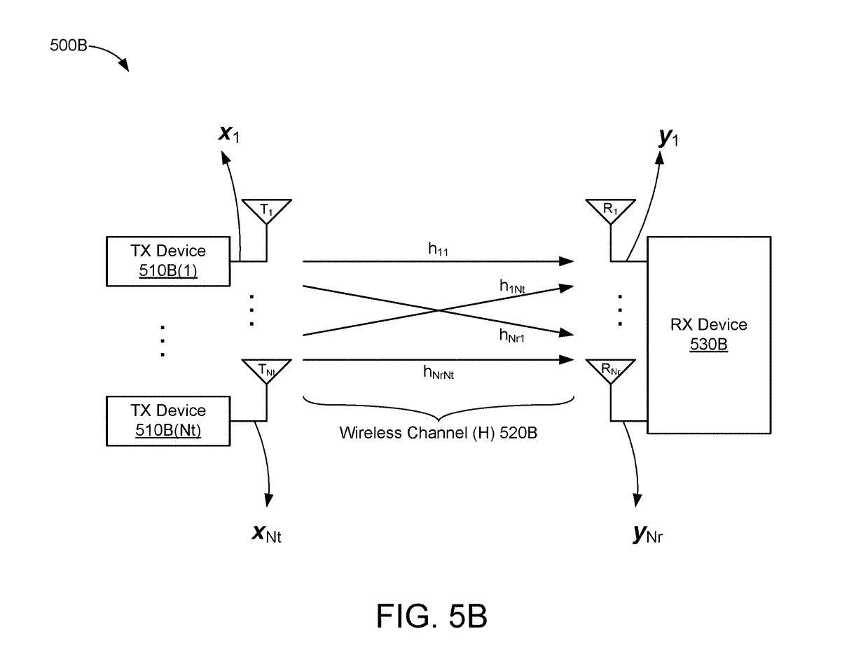

FIG. 5A shows an example communications system 500A including a TX device 510A, a RX device 530A, and a wireless channel 520A within which the example embodiments may be implemented. For purposes of discussion herein, the TX device 510A may be one of the stations STA1-STA4 of FIG. 1, and the RX device 530A may be the AP 110 of FIG. 1. For another embodiment, the TX device 510A may be a first STA, and the RX device 530A may be a second STA. For yet another embodiment, both the TX device 510A and the RX device 530A may be APs. Although not shown in FIG. 5 for simplicity, RX device 530A may include one or more MIMO receivers, for example, such as MIMO receiver 400 of FIG. 4.

As depicted in FIG. 5A, the TX device 510A transmits signals x onto wireless channel 520A, and the RX device 530A receives signals y via the wireless channel 520A. As mentioned above with respect to FIG. 1, the WLAN 120 may provide MIMO functionality. As such, the TX device 510A and RX device 530A may each be configured for MIMO communications, for example, so that TX device 510A may transmit multiple streams of data, concurrently, to the RX device 530A. MIMO communications between a single TX device and a single RX device (e.g., as depicted in FIG. 5A) are typically conducted using SU-MIMO techniques. For example, TX device 510A may include a number Nₜ of transmit antennas T₁-T_{Nt}, and RX device 530A may include a number Nᵣ of receive antennas R₁-R_{Nr}. The TX device 510A may encode data to be transmitted to RX device 530A as an Nᵣ×Nₜ MIMO stream, and then transmit the Nᵣ×Nₜ MIMO stream to RX device 530A using N spatial streams (where N is at most the lesser of Nᵣ and NO. The RX device 530A may receive the N spatial streams, and thereafter decode data contained in the N spatial streams to recover the original data. Because the data was transmitted to RX device 530A as MIMO-encoded data, the RX device 530A uses data received by each of its antennas to recover the original data.

Through spatial multiplexing, TX device 510A may transmit a first set of data (e.g., x₁={x₁₁, x₁₂, x₁₃, . . . , x_{1M}}) on a first spatial stream (SS₁) via first transmit antenna T₁ while concurrently transmitting (N−1) other sets of data (e.g., x₂={x₂₁, x₂₂, x₂₃, . . . , x_{2M}} x_{N}={x_{N1}, x_{N2}, x_{N3}, . . . , x_{NM}}) on a number N-1 of other spatial streams (SS₂-SS_{N}) via transmit antennas T₂-T_{Nt}, respectively.

Each of the receive antennas R₁-R_{Nr} of the RX device 530A may receive a combination of data transmitted by the antennas T₁-T_{Nt} of the TX device 510A. For example, the first receive antenna R₁ may receive data from each of spatial streams SS₁-SS_{N}, the second receive antenna R₂ may receive data from each of spatial streams SS₁-SS_{N}, and so on. Channel conditions of the wireless channel 520A and/or spatial orientation of the receive antennas R₁-R_{Nr} may cause differences in the data patterns received by each of the receive antennas R₁-R_{Nr}. Thus, the data received by first receive antenna R₁ (denoted as y₁={y₁₁, y₁₂, y₁₃ . . . y_{1M}}) may differ from the data received by the N^{th} receive antenna R_{Nr} (denoted as y_{N}={y_{N1}, y_{N2}, y_{N3}, . . . , y_{NM}}). In some example embodiments, a received data vector y may be determined from signals received at antennas R₁-R_{Nr} using MIMO receiver 400 of FIG. 4.

The wireless channel 520A may be modeled as an Nᵣ×Nₜ channel matrix H:

$$H = [ \begin{matrix}{h}_{11} & … & {h}_{1 Nt} \\ ⋮ & ⋱ & ⋮ \\ {h}_{Nr 1} & … & {h}_{NrNt}\end{matrix} ]$$

The received data vector y may be expressed as a function of the transmitted data (x):

y=Hx+u (1)

where y=[y₁ . . . y_{N}_{ᵣ}], x=[x₁, . . . , x_{N}_{ₜ}],and u=[u₁ . . . u_{N}_{ᵣ}]^{T} is the noise component due to thermal noise or other interference (typically modeled as a zero mean complex Gaussian circularly symmetric noise vector with E[uu*]=σ² I). The representative channel matrix H for the wireless channel 520A may be determined by the RX device 530A, for example, using channel estimation logic 435 of MIMO receiver 400 (e.g., using pilot tones or based on a transmitted preamble).

For the example embodiment of FIG. 5A, the TX device 510A may use MIMO encoding techniques to encode data to be transmitted to the RX device 530A as N MIMO streams (MU₁-MU_{N}). The first signal is received by antenna R₁, and the k^{th} signal is received by antenna Rₖ (k ranging from 1 to Nᵣ). The N MIMO streams MU₁-MU_{N} may be concurrently transmitted from TX device 510A to RX device 530A using spatial streams SS₁-SS_{N}. The RX device 530A may receive and independently decode the N MIMO streams MU₁-MU_{N}.

FIG. 5B shows an example communications system 500B including a plurality of TX devices 510B(1)-510B(Nₜ), a RX device 530B, and a wireless channel 520B. For purposes of discussion herein, each of the TX devices 510B(1)-510B(Nₜ) may be one of the stations STA1-STA4 of FIG. 1, and the RX device 530B may be the AP 110 of FIG. 1.

As depicted in FIG. 5B, the TX devices 510B(1)-510B(Nₜ) transmit signals onto wireless channel 520B, and the RX device 530B receives the signals via the wireless channel 520B. As mentioned above with respect to FIG. 1, the WLAN 120 may provide MIMO functionality. As such, the TX devices 510B(1)-510B(Nₜ) and RX device 530B may each be configured for MIMO communications, for example, so that TX devices 510B(1)-510B(Nₜ) may each transmit one or more streams of data, concurrently, to the RX device 530B. MIMO communications between multiple TX devices and a single RX device (e.g., as depicted in FIG. 5B) are typically conducted using MU-MIMO techniques. For example, if the TX devices 510B(1)-510B(Nₜ) each have 1 antenna and the RX device 530B includes Nᵣ antennas, then the TX devices 510B(1)-510B(Nₜ) may each encode data to be transmitted to RX device 530B into a corresponding MIMO stream, and then transmit the corresponding MIMO stream to RX device 530B as a single spatial stream. The RX device 530B may receive the N spatial streams, and thereafter decode data contained in the N spatial streams to recover the original data transmitted from each of TX devices 510B(1)-510B(Nₜ). Because the data was transmitted to RX device 530B as MU-MIMO encoded data, the RX device 530B uses data received by each of its antennas R₁-R_{Nr} to recover the original data (e.g., data transmitted from TX device 510A).

More specifically, the first TX device 5106(1) may transmit a first set of data (e.g., x₁={x₁₁, x₁₂, x₁₃, . . . , x_{1M}}) as a first spatial stream (SS₁) via a first transmit antenna T₁. Concurrently, each of the other TX devices 510B(2)-510B(N) may transmit a different set of data as another spatial stream via its transmit antenna. For example, each k^{th} TX device 510B(k) may transmit a set of data (e.g., xₖ={xₖ₁, xₖ₂, xₖ₃, . . . , x_{kM}}) on a k^{th} spatial stream SSₖ via a corresponding transmit antenna Tₖ.

Similarly to FIG. 5A, each of the receive antennas R₁-R_{Nr} of the RX device 530B may receive a combination of data transmitted by the antennas T₁-T_{Nt} of the TX devices 510B(1)-510B(Nt), respectively. The received data vector y and the channel estimate matrix H may also be determined in a manner similar to that described above with respect to FIG. 5A.

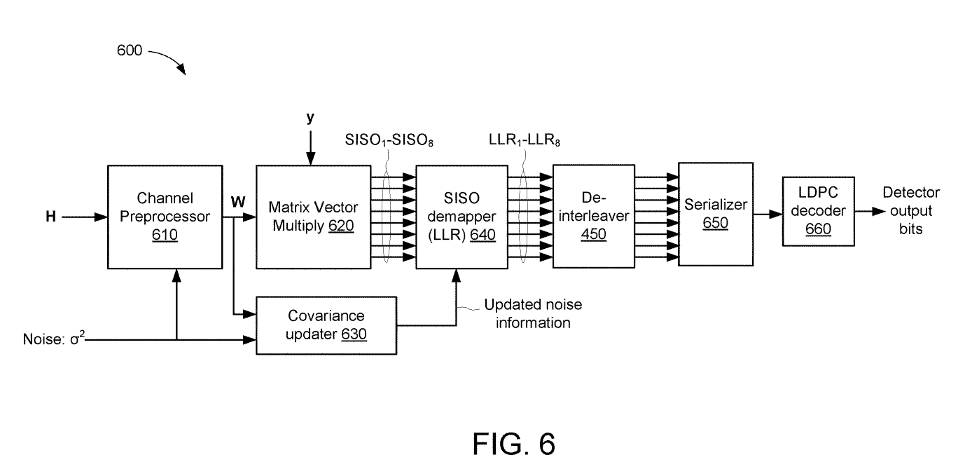

MIMO detectors, such as MIMO detector 440 of FIG. 4, typically include linear detectors that may be classified as zero-forcing (ZF) detectors or as minimum mean-squared error (MMSE) detectors. For example, FIG. 6 shows an example MIMO detector 600 that may be a ZF detector or an MMSE detector. MIMO detector 600 may be one embodiment of MIMO detector 440, serializer 445, de-interleaver 450, and FEC decoder 455 of FIG. 4. As shown in FIG. 6, MIMO detector 600 may apply a spatial filter (in the form of a weight matrix W) to the received signal vector y, and separate the received signal vector y into multiple single-input single-output (SISO) streams, from which log likelihood ratios (LLRs) may be determined. Thereafter, an estimate of the transmitted bit stream may be determined from the LLRs.

As depicted in FIG. 6, MIMO detector 600 may receive a channel matrix H, a receive data vector y, and a noise variance σ². Channel matrix H and noise variance σ² may be provided to a channel preprocessor 610. Channel preprocessor 610 may determine a weight matrix W. For linear zero-forcing (ZF) detectors, the weight matrix W_{ZF} may be expressed as:

W_{ZF}=(H*H)⁻¹H*

where * denotes the matrix conjugate transpose.
While for linear minimum mean-squared error (MMSE) detectors, the weight matrix W_{MMSE} may be expressed as:

W_{MMSE}=(H*H±σ²I_{N}_{ᵣ})⁻¹H*

where I_{N}_{ᵣ} is the identity matrix of dimension Nᵣ×Nᵣ (and N is the number of receive antennas).

The weight matrix W (W_{ZF} or W_{MMSE}) is applied to the receive data vector y by matrix vector multiply logic 620, for example, to generate multiple SISO streams, each corresponding to a spatial stream. For example, if the MIMO detector 600 supports 8 spatial stream detection, then matrix vector multiply logic 620 may output 8 SISO streams SISO₁-SISO₈, as shown in FIG. 6. The SISO streams SISO₁-SISO₈ may be provided to SISO demapper 640. Because the received data vector y includes channel noise as well as signal information, when the received data vector y is multiplied by weight matrix W, the noise is weighted as well. Consequently, the covariance of the noise may be updated by covariance updater 630, which in turn may provide updated noise information to SISO demapper 640. SISO demapper 640 may use the SISO streams SISO₁-SISO₈ and the updated noise information to determine a log likelihood ratio (LLR) stream for each of the SISO streams SISO₁-SISO₈. LLRs may also be referred to as soft bits. The resulting LLR streams LLR₁-LLR₈ may be provided to de-interleaver 450, which de-interleaves the LLR₁-LLR₈ streams. In the case of SU-MIMO, the resultant de-interleaved LLR streams may be provided to a serializer 650, which in turn may generate a serial data stream based on the LLR streams LLR₁-LLR₈. For some embodiments, the serializer 650 may be implemented as a multiplexer, for example, as discussed above with respect to the serializer 445 of FIG. 4. In the case of multi-user MIMO (MU-MIMO), the LLR streams from all the users are not multiplexed together for decoding, instead the LLR streams belonging to given transmitter would be decoded separately.

The serial data stream may be provided to a low-density parity check (LDPC) decoder 660 (or other suitable forward error correction (FEC) circuit depending on the encoding at the transmitter). The LDPC decoder 660 may generate a number detector output bits based on the serial data stream. The resulting detector output bits may represent an estimate of the received data (e.g., data transmitted by TX device 510A of FIG. 5A).

While the example linear MIMO detector methods, as described earlier and depicted in FIG. 6, have low complexity, maximum likelihood (or near maximum likelihood) methods may achieve better performance. The near ML MIMO detector, based on the maximum log Max-Log-MAP approximation, produces the i^{th} soft-output bit of the n^{th} symbol (bₙᵢ) as

$$LLR ( {b}_{ni} ) = {min}_{{x}_{n} ∈ {X}_{ni}^{+} , \overline{x} ∈ X \times … \times X} D ( x ) - {min}_{{x}_{n} ∈ {X}_{ni}^{+} , \overline{x} ∈ X \times … \times X} D ( x )$$

$${X}_{ni}^{+} = \{ {x}_{n} ∈ X \text{:} {b}_{ni} = 0 \} , {X}_{ni}^{-} = \{ {x}_{n} ∈ X \text{:} {b}_{ni} = 1 \}$$

$$\overline{x} = {[ {\begin{matrix}{x}_{1} & … & {x}_{n - 1} & {x}_{x + 1} & … & {x}_{N}\end{matrix}}_{t} ]}^{T}$$

$$where D ( x ) = \frac{1}{{σ}^{2}} {‖ \tilde{y} - Hx ‖}^{2} .$$

For example, assuming a system uses 1024 quadrature amplitude modulation (QAM) symbols and supports 8 spatial streams, a near ML MIMO detector configured for such a system may have complexity on the order of O(2^{8x10})=O(2⁸), which may be impractical to implement.

While an MIMO detector core configured to support 8 spatial streams using near ML is not practical to implement (e.g., due to the exponential increase in computational complexity, as compared with a single MIMO detector core configured to support 4 spatial streams), Applicant has discovered that multiple MIMO detector cores configured to support 4 spatial streams (hereinafter denoted as “4-spatial stream MIMO cores”) may be used to support 8 or more spatial streams by decomposing the channel—using projections—into two or more sub-channels of lower dimension. Each of these lower-dimension sub-channels may then be detected using an efficient 4-spatial stream MIMO core. Some example embodiments may employ an orthogonal null projection MIMO detection technique, while other example embodiments may employ a pre-whitening non-orthogonal projection technique.

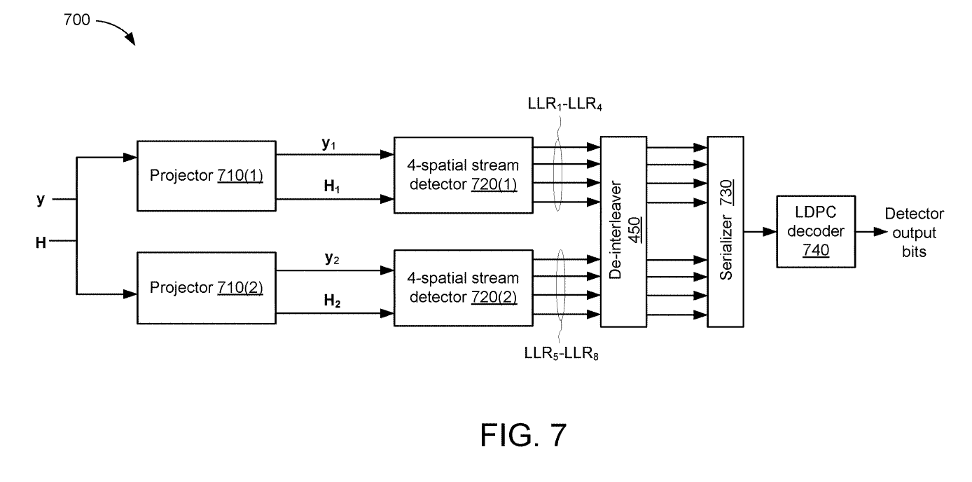

FIG. 7 depicts an example MIMO detector 700, in accordance with example embodiments. MIMO detector 700 may be one embodiment of MIMO detector 440, serializer 445, de-interleaver 450, and FEC decoder 455 of FIG. 4. As depicted in FIG. 7, MIMO detector 700 may receive a channel matrix H and a received data vector y. In other embodiments, MIMO detector 700 may also receive a noise variance σ². The channel matrix H and the receive data vector y may each be provided to projectors 710(1) and 710(2), which may perform projection operations such as an orthogonal null-projection or a pre-whitening non-orthogonal projection. More specifically, each of projectors 710(1) and 710(2) may perform channel decomposition operations on the channel matrix H and the received data vector y to generate a corresponding set of received vectors and an effective sub-channel matrix. For example, first projector 710(1) generates a received data vector y, and a first channel sub-matrix, and the second projector 710(2) generates a second received data vector y₂ a second channel sub-matrix.

The first second received data vector y₁ and the first channel sub-matrix are provided to a first 4-spatial stream detector 720(1), and the second received data vector y₂ and second channel sub-matrix are provided to a second 4-spatial stream detector 720(2). In response, the first 4-spatial stream detector 720(1) may generate a first set of log likelihood ratio (LLR) streams LLR₁ . . . LLR_{N}_{ₛₛ₁} and the second 4-spatial stream detector 720(2) may generate a second set of LLR streams LLR₁ . . . LLR_{N}_{ₛₛ₂}. The LLR streams LLR₁ . . . LLR_{N}_{ₜ} may be provided to de-interleaver 450, which de-interleaves the streams. The resultant de-interleaved LLR streams may be provided to a serializer 730, which in turn may generate a serial data stream based on the LLR streams LLR₁ . . . LLR_{N}_{ₜ}. For some embodiments, the serializer 730 may be implemented as a multiplexer, for example, as discussed above with respect to the serializer 445 of FIG. 4.

The serial data stream may be provided to LDPC decoder 740 (or other suitable FEC circuit). The LDPC decoder 740 may generate a number detector output bits based on the serial data stream. The resulting detector output bits may represent an estimate of the received data (e.g., data transmitted by TX device 510A of FIG. 5A).

Although the example of FIG. 7 depicts a single decoder (LDPC decoder 740) to receive the serial data stream, for other embodiments, multiple decoders may be provided in the MIMO detector 700. For example, for embodiments employing MU-MIMO, a separate decoder (e.g., LDPC decoder 740) may be provided for each spatial stream. Accordingly, for MU-MIMO embodiments including multiple spatial streams, there may be a number of decoders (e.g., 8 decoders) rather than a single decoder, as depicted in FIG. 7. For other embodiments, a single decoder (e.g., LDPC decoder 740) may be clocked at a sufficiently high speed to allow the decoder to be shared between multiple users (e.g., the user TX devices 510A(1)-510A(Nₜ) of FIG. 5B).

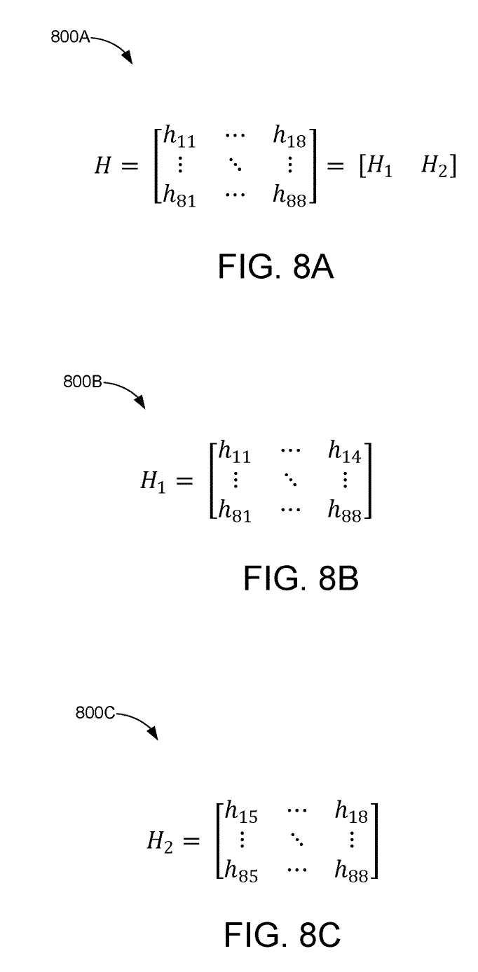

FIG. 8A shows a channel matrix H for a channel including Nₜ spatial streams, in accordance with the example embodiments. The channel matrix H may be considered as two sub-matrices H₁ and H₂, which are respectively depicted in FIGS. 8B and 8C. In some example embodiments, Nₜ=8, and the resulting two sub-matrices may be of dimensions 8×4. However, in general for Nₜ<8, then the two sub-matrices H₁ and H₂ are of dimensions Nᵣ×Nₛₛ_{₁} and Nᵣ×Nₛₛ_{₂}, respectively and Nₛₛ_{₁}+Nₛₛ_{₂}=Nₜ. Therefore, the received data stream of equation (1) may be expressed as:

y=H₁x₁+H₂x₂+u (1a)

where the sub-matrices H₁ and H₂ may be as shown in respective FIGS. 8B and 8C, and the transmit data x may be represented by x₁=[x₁ x₂ x₃ x₄]^{T} and x₂=[x₅ x₆ x₇ x₈]^{T} for the example where Nₜ=8. In general, x₁=[x₁ x₂ . . . x_{N}_{ₛₛ₁}]^{T} of dimension N_{SS1}×1 and x₂=[x_{N}_{_{SS1}}₊₁ . . . x_{N}_{ₜ}]^{T} of dimension N_{SS2}×1=(Nₜ−N_{SS1})×1.

The channel sub-matrices H₁ and H₂ may be decomposed using OR decomposition as

H₁=Q₁R₁H₂=Q₂R₂

Because the channel sub-matrices H₁ and H₂ are tall matrices, the QR decompositions may be “economy size” decompositions, for example, that reduce the number of calculations required (e.g., as compared with the full channel matrix H). Thus, rather than determining an 8×8 orthogonal Q and an 8×4 upper triangular R, the economy size decomposition only determines the first 4 columns of Q (i.e., an 8×4 matrix Q with orthonormal columns) and the first 4 rows of R (i.e., a square 4×4 upper triangular R). A generalization for other numbers of spatial streams is shown in Table 1 below

TABLE 1
Sub-matrix dimensions as a function of the number of spatial streams.

| | Num. of Spatial Streams decomposition | | | | | |
|---|---|---|---|---|---|---|
| | 5 | 5 | 6 | 6 | 7 | 8 |
| | (3.2) | (4.1) | (3.3) | (4.2) | (4.3) | (4.4) |
| Dimensions of | 8 × 3, | 8 × 4, | 8 × 3, | 8 × 4, | 8 × 4, | 8 × 4, |
| submatrices | 8 × 2 | 8 × 1 | 8 × 3 | 8 × 2 | 8 × 3 | 8 × 4 |
| H₁, and H₂ | | | | | | |

According to some example embodiments, an orthogonal null projection MIMO detection technique may be used to decompose a channel into two channels including fewer spatial streams (e.g., decomposing an 8 spatial stream channel into two 4 spatial stream sub-channels). For example, such a technique may be used by projectors 710(1) and 710(2) of FIG. 7. In such embodiments, two null projection matrices may be calculated based on the channel sub-matrices H₁ and H₂. Each null projection matrix may have a dimension of A Tᵣ×Nᵣ, where Nᵣ is the number of receiving antennas (and may be 8 in some example embodiments). The projections may be constructed to put H₂ into the null space of H₁ (and similarly, to put H₁ into the null space of H₂). The two null projection matrices may be expressed as:

P₁=I_{N}_{ᵣ}−H₂(H*₂H₂)⁻¹H*₂

P₂=I_{N}_{ᵣ}−H₁(H*₁H₁)⁻¹H*₁

where I_{N}_{ᵣ} is the identity matrix of size Nᵣ×Nᵣ. In some embodiments, the QR decompositions of H₁ and H₂ may be used to simplify the calculations of P₁ and P₂ and provide:

P₁=I_{N}_{ᵣ}−Q₂Q*₂

P₂=I_{N}_{ᵣ}−Q₁Q*₁

Because Nₛₛ_{₁} and Nₛₛ_{₂} degrees of freedom are consumed nulling respective subchannels H₂ and H₁, the projection matrices P₁ and P₂ are not full rank. Instead,

rank (P₁)=Nᵣ−Nₛₛ_{₂}

rank (P₂)=Nᵣ−Nₛₛ_{₁}

Thus, if the number of spatial streams is 8, then the projection matrices will have a rank of 4.

The projection matrices can be applied to the received vector y to produce two new vectors

y₁=P₁⁺\tilde{y} of dimension Nᵣ×1

y₂=P₂⁺\tilde{y} of dimension Nᵣ×1

Since the projection matrices are not full rank, then their dimensions can be reduced by multiplying each of P₁ and P₂ with a combining matrix (a linear combination of the rows of the projection matrix) to yield:

W₁=P₁C₁

W₂=P₂C₂

where C₁ is of dimension Nᵣ×(Nᵣ−N_{SS2}) and C₂ is of dimension Nᵣ×(Nᵣ−N_{SS1}). An example of the combining matrices C₁ and C₂ may be Walsh-Hadamard matrices or other matrices. Each of the reduced dimension projection matrices can be written in terms of their QR-decomposition as

W₁=\tilde{Q}₁\tilde{R}₁

W₂=\tilde{Q}₂\tilde{R}₁

The dimensions of the new projection matrices W₁ and W₂ are Nᵣ×(Nᵣ−N_{SS2}) and Nᵣ×(Nᵣ−N_{SS1}), respectively. The final projection matrices W₁ and W₂ may be given by

W₁=\tilde{Q}₁ of dimension Nᵣ×(Nᵣ−N₂)

W₂=\tilde{Q}₂ of dimension Nᵣ×(Nᵣ−N₁)

From these sub-channel weight matrices, the vector inputs to the 4-spatial stream detectors 720(1)-720(2) may be determined as follows:

y₁=W*₁y of dimension (Nᵣ−N_{SS2})×1

y₂=W*₂y of dimension (Nᵣ−N_{SS2})×1

The inputs to the two 4 spatial stream MIMO detectors are y₁ and y₂ with the effective channels matrices given by

\tilde{H}₁=W*₁H₁ of dimension (Nᵣ−N_{SS2})×N_{SS1}

\tilde{H}₂=W*₂H₂ of dimension (Nᵣ−N_{SS2})×N_{SS2}

In accordance with other embodiments, a pre-whitening non-orthogonal projection MIMO detection technique may be used to decompose a channel into two sub-channels including fewer spatial streams (e.g., decomposing an 8 spatial stream channel into two 4 spatial stream sub-channels). For example, such a technique may be used by projectors 710(1) and 710(2) of FIG. 7. In such embodiments, the system may be modeled as:

y=H₁x₁+H₂x₂+u (1a)

Assuming 8 spatial streams are to be decomposed into two 4 spatial stream sub-channels, at a first of the 4 spatial stream detectors, equation (1a) may be rearranged to yield:

y=H₁×₁+u₁ where u₁=H₂x₂±u

The noise covariance matrix of u₁ may be expressed as:

Rᵤ_{₁}ᵤ_{₁}=H₂H*₂+σ² I_{N}_{ᵣ}

and the input (z₁) to the first 4-spatial stream detector 720(1) may be pre-whitened by:

z₁=(EₓH₂H*₂+σ²I_{N}^{r})^{-1/2}y=Rᵤ_{₁}ᵤ_{₁}^{-1/2}y

where Eₓ, is the average QAM symbol energy. After pre-whitening, the effective channel size for x₁ is 8×4:

\tilde{H}₁=Rᵤ_{₁}ᵤ_{₁}^{-1/2}H₁

and the resulting noise and interference is white.

Similar operations may result in a similar pre-whitening matrix for the second 4-spatial stream detector 720(2):

z₂=(EₓH₁H*₁+σ²I_{N}_{ᵣ})^{-1/2}y=Rᵤ_{₂}ᵤ_{₂}^{-1/2}y

and x₂ may similarly have an effective 8×4 channel with white noise:

\tilde{H}₂=Rᵤ_{₂}ᵤ_{₂}^{-1/2}H₂

While the example embodiments are described as decomposing channels into 4 spatial stream sub-channels for detection by 4-spatial stream detectors, other embodiments may provide for other decompositions. For example, rather than decomposing an 8 spatial stream channel into two 4 spatial stream sub-channels (e.g., an 8 to 4+4 decomposition), other example embodiments may provide an 8 to 4+2+2 decomposition, an 8 to 2+2+2+2 decomposition, or other suitable decompositions. In such decompositions, other types of MIMO detectors may be used such as, for example, 2-spatial stream MIMO detectors or 3-spatial stream MIMO detectors. Additionally, wireless channels may have fewer than 8 spatial streams. For example, some embodiments may provide a 6 to 4+2 decomposition (e.g., for use in a wireless channel including 6 spatial streams).

Some wireless channels may have more than 8 spatial streams. Thus, for other embodiments, multiple stages of projections may iteratively decompose the wireless channel into a number of sub-channels each including a predetermined number (or less) of spatial streams, for example, so that a given set of the predetermined number of spatial streams may be detected by a MIMO detector core having a certain (acceptable) level of computational complexity. For at least one example implementation, the predetermined number is equal to four (4), for example, so that the 4-spatial stream detectors 720(1)-720(2) of FIG. 7 may be used to iteratively decompose the wireless channel. For example, in a MIMO decoder implemented in a wireless network or system including 16 spatial streams, a first projection stage of the MIMO decoder may decompose the wireless channel into two 8 spatial stream sub-channels, and a second projection stage of the MIMO decoder may decompose each of the two 8 spatial stream sub-channels into two corresponding 4 spatial stream sub-channels. The resulting four sets of 4 spatial streams may then be detected by a set of four 4-spatial stream MIMO detectors such as, for example, the 4-spatial stream detectors 720(1)-720(2) of FIG. 7.

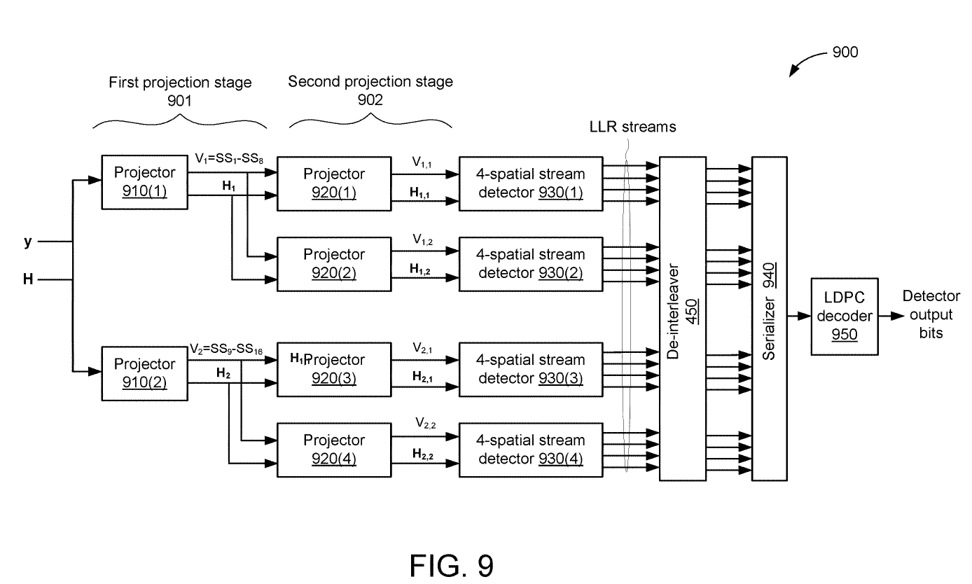

FIG. 9 depicts a MIMO detector 900 including two projection stages 901 and 902, in accordance with example embodiments. MIMO detector 900 may be one embodiment of MIMO detector 440, serializer 445, de-interleaver 450, and FEC decoder 455 of FIG. 4. As depicted in FIG. 9, MIMO detector 900 may receive a channel matrix H and a receive data vector y, both including N spatial streams. Although not shown in FIG. 9, for some embodiments, a noise variance G² may also be provided as an input to the first stage projectors 910(1) and 910(2). The channel matrix H and the receive data vector y may each be provided to a set of two (2) first stage projectors 910(1) and 910(2). Each of the first stage projectors 910(1) and 910(2) may decompose the channel into two sub-channels each including N/2 spatial streams. More specifically, the first stage projector 910(1) may generate a first N/2 (which may be 8 if the N is 16) spatial stream receive data vector V₁ corresponding to spatial streams SS₁-SS₈ and a first effective N/2 spatial stream sub-channel matrix H₁, and the first stage projector 910(2) may generate a second N/2 spatial stream receive data vector V₂ corresponding to spatial streams SS₉-SS₁₆ and a second effective N/2 spatial stream sub-channel matrix H₂. In some embodiments, the first stage projectors 910(1) and 910(2) may perform channel decomposition operations using orthogonal null projection techniques or pre-whitening non-orthogonal projection techniques, as described above.

The first N/2 spatial stream receive data vector V₁ and the first effective N/2 spatial stream sub-channel matrix H₁ are provided to second stage projectors 920(1) and 920(2). Similarly, the second N/2 spatial stream receive data vector V₂ and the second effective N/2 spatial stream sub-channel matrix H₂ are provided to second stage projectors 920(3) and 920(4). Second stage projectors 920(1)-920(4) may each decompose a corresponding effective N/2 spatial stream sub-channel into two sub-channels each including N/4 spatial streams. In some embodiments, second stage projectors 920(1)-920(4) may perform channel decomposition operations using orthogonal null projection techniques or pre-whitening non-orthogonal projection techniques, as described above. For some implementations, the first stage projectors 910(1)-910(2) and/or the second stage projectors 920(1)-920(4) may be embodiments of projectors 710(1)-710(2) of FIG. 7.

After decomposing the effective sub-channels, second stage projectors 920(1)-920(4) may each generate an N/4 spatial stream receive data vector and an effective N/4 spatial stream sub-channel matrix. More specifically, projector 920(1) generates a N/4 spatial stream receive data vector V_{1,1} and an effective N/4 spatial stream sub-channel matrix H_{1,1}, projector 920(2) generates a N/4 spatial stream receive data vector V_{1,2} and an effective N/4 spatial stream sub-channel matrix H_{1,2}, projector 920(3) generates a N/4 spatial stream receive data vector V_{2,1} and an effective N/4 spatial stream sub-channel matrix H_{2,1}, and projector 920(4) generates a N/4 spatial stream receive data vector V_{2,2} and an effective N/4 spatial stream sub-channel matrix H_{2,2}.

Each pair of N/4 spatial stream receive data vectors and effective N/4 spatial stream sub-channel matrices are provided to a respective one of four 4-spatial stream detectors 930(1)-930(4). The four 4-spatial stream detectors 930(1)-930(4), which may be embodiments of the 4-spatial stream MIMO detectors 720(1)-720(2) of FIG. 7, may each generate an LLR stream for a corresponding set of N/4 spatial streams. The resultant LLR streams may be provided to de-interleaver 450, which de-interleaves the LLR streams. The resultant de-interleaved LLR streams may be provided to a serializer 940, which in turn may generate a serial data stream based on the LLR streams. For some embodiments, the serializer 940 may be implemented as a multiplexer, for example, as discussed above with respect to the serializer 445 of FIG. 4.

The serial data stream may be provided to LDPC decoder 950 (or other suitable FEC circuit), which in turn may generate a number of detector output bits based on the serial data stream. The detector output bits may together form an estimate of the transmitted signal (e.g., of a bit stream transmitted by TX device 510A of FIG. 5A).

Further, although the example MIMO detector 900 of FIG. 9 is described with respect to a channel including 16 spatial streams and is shown to include two stages of projection 901 and 902, in other embodiments, the channel may include other numbers of spatial streams, and the MIMO detector 900 may include greater numbers of stages of projection. For example, a three stage MIMO detector may support 3-stage detection of 32 spatial streams, according to some embodiments.

FIG. 10 shows a flowchart depicting an example operation 1000 for detecting data transmitted using multiple-input multiple-output (MIMO) communications. Operation 1000 may be performed by any suitable wireless receiver, such as AP 110 or STAs 1-4 of FIG. 1, STA 200 of FIG. 2, AP 300 of FIG. 3, MIMO receiver 400 of FIG. 4, RX device 530A of FIG. 5A, RX device 530B of FIG. 5B, MIMO detector 700 of FIG. 7, or MIMO detector 900 of FIG. 9.

With respect to FIG. 10, a MIMO detector may receive, on a wireless channel, the data as a plurality of spatial streams (1001). In some implementations, data may be transmitted as 8 spatial streams. In some examples, the MIMO detector may receive the plurality of spatial streams using multiple antennas, such as antennas 250(1)-250(n) of STA 200 of FIG. 2, or antennas 360(1)-360(n) of AP 300 of FIG. 3, or antennas 460(1)-460(n) of MIMO receiver 400 of FIG. 4.

The MIMO detector may also receive a channel matrix characterizing the wireless channel (1002). In some embodiments, the channel matrix may be determined by channel estimation logic 435 of MIMO receiver 400 of FIG. 4, by executing decomposition and projection software module 243 of STA 200 of FIG. 2, or by executing decomposition and projection software module 343 of AP 300 of FIG. 3.

Then, the MIMO detector may decompose the channel matrix into a first sub-channel matrix and a second sub-channel matrix, the first sub-channel matrix and the second sub-channel matrix each having a lower dimension than the channel matrix (1003). In some embodiments, this decomposition may be performed by executing decomposition and projection software module 243 of STA 200 of FIG. 2, by executing decomposition and projection software module 343 of AP 300 of FIG. 3, using projector 710(1) and 710(2) of MIMO detector 700 of FIG. 7, or using N/2 detector 910(1) and 910(2) of MIMO detector 900 of FIG. 9. In some examples, decomposing the channel into the first sub-channel matrix may include applying a first projection matrix to the channel matrix, and decomposing the channel into the second sub-channel matrix may include applying a second projection matrix to the channel matrix (1003A). In some embodiments, the first projection matrix and the second projection matrix may each be an orthogonal null-projection matrix (1003B). In other embodiments, the first projection matrix and the second projection matrix may each be a non-orthogonal pre-whitening projection matrix (1003C). The first sub-channel matrix may characterize a first effective channel for a first subset of the plurality of spatial streams, and the second sub-channel matrix may characterize a second effective channel for a second subset of the plurality of spatial streams (1003D).

After decomposing the channel matrix, the MIMO detector may generate a first estimated data signal based at least in part on the plurality of spatial streams and the first sub-channel matrix (1004). In some examples, this determination may be made by executing MIMO detection software module 244 or decoder software module 245 of STA 200 of FIG. 2, by executing MIMO detection software module 344 or decoder software module 345 of AP 300 of FIG. 3, by using MIMO detector 440 of MIMO receiver 400 of FIG. 4, by using the 4-spatial stream detectors 720(1) and 720(2) of FIG. 7, or by using the 4-spatial stream detectors 930(1)-930(4) of FIG. 9.

The MIMO detector may also generate a second estimated data signal based at least in part on the plurality of spatial streams and the second sub-channel matrix (1005). In some examples, this determination may be made by executing MIMO detection software module 244 or decoder software module 245 of STA 200 of FIG. 2, by executing MIMO detection software module 344 or decoder software module 345 of AP 300 of FIG. 3, by using MIMO detector 440 of MIMO receiver 400 of FIG. 4, by using the 4-spatial stream detectors 720(1) and 720(2) of FIG. 7, or by using the 4-spatial stream detectors 930(1)-930(4) of FIG. 9.

Then, the MIMO detector may combine the first and second estimated data signals to recover the data (1006). In some examples, the first and second estimated data signals may be combined by executing MIMO detection software module 244 or decoder software module 245 of STA 200 of FIG. 2, by executing MIMO detection software module 344 or decoder software module 345 of AP 300 of FIG. 3, by using MIMO detector 440 of MIMO receiver 400 of FIG. 4, by using the serializer 730 of FIG. 7, or by using the serializer 940 of FIG. 9.

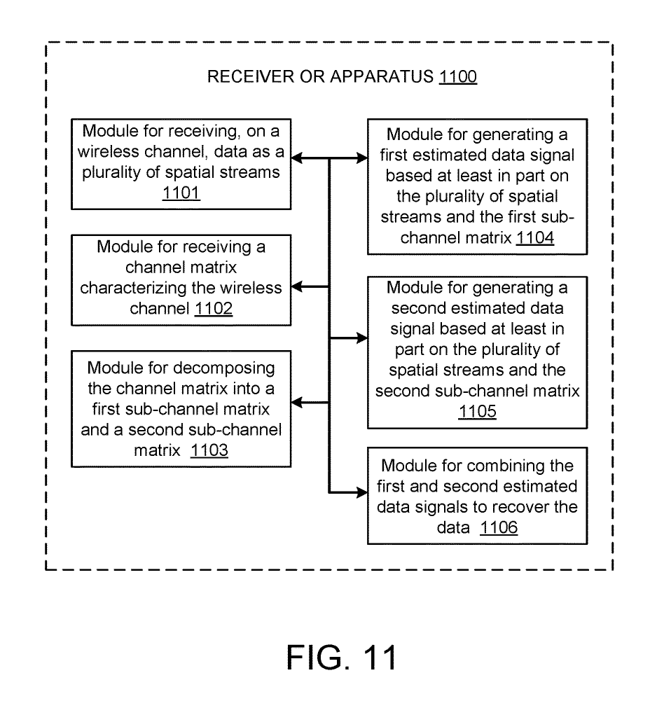

FIG. 11 shows an example MIMO receiver or apparatus 1100 represented as a series of interrelated functional modules. A module 1101 for receiving, on a wireless channel, data as a plurality of spatial streams may correspond at least in some aspects to, for example, a processor as discussed herein (e.g., processor 230 of FIG. 2 and/or processor 330 of FIG. 3) and/or a number of antennas as discussed herein (e.g., antennas 250(1)-250(n) of FIG. 2, antennas 360(1)-360(n) of FIG. 3, and/or antennas 460(1)-460(n) of FIG. 4). A module 1102 for receiving a channel matrix characterizing the wireless channel may correspond at least in some aspects to, for example, a processor as discussed herein (e.g., processor 230 of FIG. 2 and/or processor 330 of FIG. 3) and/or a number of antennas as discussed herein (e.g., antennas 250(1)-250(n) of FIG. 2, antennas 360(1)-360(n) of FIG. 3, and/or antennas 460(1)-460(n) of FIG. 4). A module 1103 for decomposing the channel matrix into a first sub-channel matrix and a second sub-channel matrix may correspond at least in some aspects to, for example, a processor as discussed herein (e.g., processor 230 of FIG. 2 and/or processor 330 of FIG. 3) and/or a projector as discussed herein (e.g., projectors 710(1)-710(2) of FIG. 7). A module 1104 for generating a first estimated data signal based at least in part on the plurality of spatial streams and the first sub-channel matrix may correspond at least in some aspects to, for example, a processor as discussed herein (e.g., processor 230 of FIG. 2 and/or processor 330 of FIG. 3) and/or a 4-spatial stream detector as discussed herein (e.g., 4-spatial stream detector 720(1) of FIG. 7). A module 1105 for generating a second estimated data signal based at least in part on the plurality of spatial streams and the second sub-channel matrix may correspond at least in some aspects to, for example, a processor as discussed herein (e.g., processor 230 of FIG. 2 and/or processor 330 of FIG. 3) and/or a 4-spatial stream detector as discussed herein (e.g., 4-spatial stream detector 720(2) of FIG. 7). A module 1106 for combining the first and second estimated data signals to recover the data may correspond at least in some aspects to, for example, a processor as discussed herein (e.g., processor 230 of FIG. 2 and/or processor 330 of FIG. 3) and/or a serializer as discussed herein (e.g., serializer 650 of FIG. 6, serializer 730 of FIG. 7, and/or serializer 940 of FIG. 9).

The functionality of the modules of FIG. 11 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 11, as well as other components and functions described herein, may be implemented using any suitable means. Such means also may be implemented, at least in part, using corresponding structure as taught herein. For example, the components described above in conjunction with the “module for” components of FIG. 11 also may correspond to similarly designated “means for” functionality. Thus, in some aspects one or more of such means may be implemented using one or more of processor components, integrated circuits, or other suitable structure as taught herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, one aspect of the disclosure can include a non-transitory computer readable media embodying a method for time and frequency synchronization in non-geosynchronous satellite communication systems. The term “non-transitory” does not exclude any physical storage medium or memory and particularly does not exclude dynamic memory (e.g., conventional random access memory (RAM)) but rather excludes only the interpretation that the medium can be construed as a transitory propagating signal.

While the foregoing disclosure shows illustrative aspects, it should be noted that various changes and modifications could be made herein without departing from the scope of the appended claims. The functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated. Accordingly, the disclosure is not limited to the illustrated examples and any means for performing the functionality described herein are included in aspects of the disclosure.

What is claimed is:

1. A method of detecting data transmitted using multiple-input multiple-output (MIMO) communications, the method comprising:
receiving, on a wireless channel, data as a plurality of spatial streams;
receiving a channel matrix characterizing the wireless channel;
decomposing the channel matrix into a first sub-channel matrix and a second sub-channel matrix, the first sub-channel matrix and the second sub-channel matrix each having a lower dimension than the channel matrix;
generating a first estimated data signal based at least in part on the plurality of spatial streams and the first sub-channel matrix;
generating a second estimated data signal based at least in part on the plurality of spatial streams and the second sub-channel matrix; and
combining the first and second estimated data signals to recover the data.

2. The method of claim 1, wherein:
generating the first estimated data signal includes generating and deinterleaving a first set of log-likelihood ratio (LLR) streams;
generating the second estimated data signal includes generating and deinterleaving a second set of LLR streams; and
combining the first and second estimated data signals includes generating estimates of a transmitted data stream using a soft-input forward error correction decoder.

3. The method of claim 1, wherein:
generating the first estimated data signal includes generating and deinterleaving a first set of log-likelihood ratio (LLR) streams;
generating the second estimated data signal includes generating and deinterleaving a second set of LLR streams;
decoding the first set of LLR streams using a soft-input forward error correction decoder; and
decoding the second set of LLR streams using the soft-input forward error correction decoder.

4. The method of claim 1, wherein the data comprises eight spatial streams, the channel matrix is an 8 by 8 matrix, and each of the first sub-channel matrix and the second sub-channel matrix is a corresponding 8 by 4 matrix.

5. The method of claim 1, wherein the first sub-channel matrix comprises a first half of the channel matrix, and the second sub-channel matrix comprises a second half of the channel matrix.

6. The method of claim 1, wherein the data comprises Nₜ<8 spatial streams, the channel matrix is an 8 by Nₜ matrix, the first sub-channel matrix is an 8 by Nₛₛ_{₁} matrix and the second sub-channel matrix is an 8 by Nₛₛ_{₂} matrix, where Nₛₛ_{₁} and Nₛₛ_{₂} add up to Nₜ.

7. The method of claim 6, wherein the first sub-channel matrix comprises columns 1 to Nₛₛ_{₁} of the channel matrix, and the second sub-channel matrix comprises columns Nₛₛ_{₁}+1 to Nₜ of the channel matrix.

8. The method of claim 1, wherein decomposing the channel matrix comprises:
applying a first projection matrix to the channel matrix to generate the first sub-channel matrix; and
applying a second projection matrix to the channel matrix to generate the second sub-channel matrix.

9. The method of claim 8, wherein the first projection matrix and the second projection matrix are each orthogonal null-projection matrices.

10. The method of claim 8, wherein the first projection matrix and the second projection matrix are each non-orthogonal pre-whitening projection matrices.

11. The method of claim 8, wherein:
applying the first projection matrix to the channel matrix comprises embedding the first sub-channel matrix into a null space of the second sub-channel matrix; and
applying the second projection matrix to the channel matrix comprises embedding the second sub-channel matrix into a null space of the first sub-channel matrix.

12. The method of claim 8, wherein:
the first projection matrix is based on row substitution of a OR decomposition of the first sub-channel matrix; and
the second projection matrix is based on row substitution of a OR decomposition of the second sub-channel matrix.

13. The method of claim 8, wherein rows of the first projection matrix are combined to produce a lower dimension matrix based on a number of spatial streams of the second sub-channel matrix; and rows of the second projection matrix are combined to produce a lower dimension matrix based on a number of spatial streams of the first sub-channel matrix.

14. The method of claim 1, wherein the first sub-channel matrix characterizes a first effective channel for a first subset of the plurality of spatial streams, and the second sub-channel matrix characterizes a second effective channel for a second subset of the plurality of spatial streams.

15. The method of claim 1, wherein decomposing the channel matrix into the first sub-channel matrix and the second sub-channel matrix comprises:
iteratively decomposing the channel matrix into a number of smaller sub-channel matrices using multiple projection stages.

16. A non-transitory computer-readable storage medium storing one or more programs containing instructions that, when executed by one or more processors of a communication device, cause the communication device to perform operations comprising:
receiving, on a wireless channel, data as a plurality of spatial streams;
receiving a channel matrix characterizing the wireless channel;
decomposing the channel matrix into a first sub-channel matrix and a second sub-channel matrix, the first sub-channel matrix and the second sub-channel matrix each having a lower dimension than the channel matrix;
generating a first estimated data signal based at least in part on the plurality of spatial streams and the first sub-channel matrix;
generating a second estimated data signal based at least in part on the plurality of spatial streams and the second sub-channel matrix; and
combining the first and second estimated data signals to recover the data.

17. The non-transitory computer-readable storage medium of claim 16, wherein the data comprises eight spatial streams, the channel matrix is an 8 by 8 matrix, and each of the first sub-channel matrix and the second sub-channel matrix is a corresponding 8 by 4 matrix.

18. The non-transitory computer-readable storage medium of claim 16, wherein the first sub-channel matrix comprises a first half of the channel matrix, and the second sub-channel matrix comprises a second half of the channel matrix.

19. The non-transitory computer-readable storage medium of claim 16, wherein execution of the instructions to decompose the channel matrix causes the communication device to perform operations further comprising:
applying a first projection matrix to the channel matrix to generate the first sub-channel matrix; and
applying a second projection matrix to the channel matrix to generate the second sub-channel matrix.

20. The non-transitory computer-readable storage medium of claim 19, wherein the first projection matrix and the second projection matrix are each orthogonal null-projection matrices.

21. The non-transitory computer-readable storage medium of claim 19, wherein the first projection matrix and the second projection matrix are each non-orthogonal pre-whitening projection matrices.

22. The non-transitory computer-readable storage medium of claim 19, wherein:
applying the first projection matrix to the channel matrix comprises embedding the first sub-channel matrix into a null space of the second sub-channel matrix; and
applying the second projection matrix to the channel matrix comprises embedding the second sub-channel matrix into a null space of the first sub-channel matrix.

23. The non-transitory computer-readable storage medium of claim 16, wherein the first sub-channel matrix characterizes a first effective channel for a first subset of the plurality of spatial streams, and the second sub-channel matrix characterizes a second effective channel for a second subset of the plurality of spatial streams.

24. The non-transitory computer-readable storage medium of claim 16, wherein execution of the instructions to decompose the channel matrix into the first sub-channel matrix and the second sub-channel matrix causes the communication device to perform operations further comprising:
iteratively decomposing the channel matrix into a number of smaller sub-channel matrices using multiple projection stages.

25. A communication device for detecting data transmitted using multiple-input multiple-output (MIMO) communications, the communication device comprising:
a number of antennas configured to receive, on a wireless channel, data as a plurality of spatial streams;
a circuit configured to receive or store a channel matrix that characterizes the wireless channel;
a first projector configured to decompose the channel matrix into a first sub-channel matrix;
a second projector configured to decompose the channel matrix into a second sub-channel matrix, the first sub-channel matrix and the second sub-channel matrix each having a lower dimension than the channel matrix;
a first detector configured to generate a first estimated data signal based at least in part on the plurality of spatial streams and the first sub-channel matrix;
a second detector configured to generate a second estimated data signal based at least in part on the plurality of spatial streams and the second sub-channel matrix;
a serializer configured to combine the first and second estimated data signals into a serial bit stream; and
a decoder configured to recover the data from the serial bit stream.

26. The communication device of claim 25, wherein the data comprises eight spatial streams, the channel matrix is an 8 by 8 matrix, and each of the first sub-channel matrix and the second sub-channel matrix is a corresponding 8 by 4 matrix.

27. The communication device of claim 25, wherein the first sub-channel matrix comprises a first half of the channel matrix, and the second sub-channel matrix comprises a second half of the channel matrix.

28. The communication device of claim 25, wherein:
the first projector is configured to decompose the channel matrix into the first sub-channel matrix by applying a first projection matrix to the channel matrix; and
the second projector is configured to decompose the channel matrix into the second sub-channel matrix by applying a second projection matrix to the channel matrix.

29. The communication device of claim 28, wherein the first projection matrix and the second projection matrix are each orthogonal null-projection matrices.

30. A communication device for detecting data transmitted using multiple-input multiple-output (MIMO) communications, the communication device comprising:
means for receiving, on a wireless channel, data as a plurality of spatial streams;
means for receiving a channel matrix characterizing the wireless channel;
means for decomposing the channel matrix into a first sub-channel matrix and a second sub-channel matrix, the first sub-channel matrix and the second sub-channel matrix each having a lower dimension than the channel matrix;
means for generating a first estimated data signal based at least in part on the plurality of spatial streams and the first sub-channel matrix;
means for generating a second estimated data signal based at least in part on the plurality of spatial streams and the second sub-channel matrix; and
means for combining the first and second estimated data signals to recover the data.
